(19) United States
(12) Patent Application Publication
(10) Pub. No.: US 2011/0216905 A1
(43) Pub. Date: Sep. 8, 2011

(54) CHANNEL COMPRESSION

(75) Inventors: Marsal Gavalda, Sandy Springs, GA (US); Mark Finlay, Tucker, GA (US)

(73) Assignee: Nexidia Inc., Atlanta, GA (US)

(21) Appl. No.: 12/718,114

(22) Filed: Mar. 5, 2010

(51) Int. Cl. H04R 5/00; G10L 19/00

(52) U.S. Cl. 381/1; 704/201; 704/E19.001

(57) ABSTRACT

Techniques implemented as systems, methods, and apparatuses, including computer program products, for logging multi-channel audio signals. The techniques include receiving a first audio input signal over a first audio channel and a second audio input signal over a second audio channel, the first audio channel and the second audio channel forming portions of a multi-channel call; generating supplemental information representative of characteristics of the first audio input signal, the second audio input signal, or both; after generating the supplemental information, combining the first audio input signal and the second audio input signal to form an audio output signal of a single-channel format; and storing the generated supplemental information in association with an identifier of the audio output signal, wherein at least a portion of the generated supplemental information is sufficient to enable information associated with the first audio input signal, the second audio input signal, or both to be derived from the audio output signal of the single-channel format.

### CROSS-REFERENCE TO RELATED APPLICATIONS

This application is related to U.S. patent application Ser. No. ______, titled “Obfuscating Sensitive Content in Audio Sources,” (Attorney Docket No.: 30004-048001), filed concurrently with the present application. The content of this application is incorporated herein by reference in its entirety.

### BACKGROUND

This description relates to channel compression.

In some audio logging systems, for example, those associated with call centers, audio signals from multiple audio channels are combined to form a monaural audio recording. For example, in a two-channel call between a call center agent and a customer, two signals may exist during a call (a “4-wire signal”) with one signal being associated with each speaker. When the call is logged by the call center's audio logging system, the signals for the two speakers are combined prior to being stored as a record of the call. The stored monaural audio recording may be processed by a number of conventional audio mining tools to extract various features from the caller-call center agent dialog. Such audio mining tools include a speech/non-speech detector, a speaker change detector, a speech recognizer, and a volume detector. The speech/non-speech detector identifies speech and certain non-speech events, e.g., silence, muzak, hangup noise, in the monaural audio recording. The speaker change detector marks speaker turns. The speech recognizer outputs sequences of words for every speaker turn. The topic detector determines a topic (or other content characteristics) at various levels. Data generated by these audio mining tools may be used to monitor and assess the call center and/or call center agent's performance.

### SUMMARY

In general, in one aspect, the invention features a method of logging multi-channel audio signals. The method includes receiving a first audio input signal over a first audio channel and a second audio input signal over a second audio channel, the first audio channel and the second audio channel forming portions of a multi-channel call; generating supplemental information representative of characteristics of the first audio input signal, the second audio input signal, or both; after generating the supplemental information, combining the first audio input signal and the second audio input signal to form an audio output signal of a single-channel format; and storing the generated supplemental information in association with an identifier of the audio output signal, wherein at least a portion of the generated supplemental information is sufficient to enable information associated with the first audio input signal, the second audio input signal, or both to be derived from the audio output signal of the single-channel format.

Embodiments of the invention include one or more of the following features.

The method of generating the supplemental information include one or more of: processing the first audio input signal either fully or in part with a first set of audio mining components to identify characteristics of the first audio input signal; and processing the second audio input signal either fully or in part with a second set of audio mining components to identify characteristics of the second audio input signal.

The first set of audio mining components may be identical to the second set of audio mining components.

The first set of audio mining components may include one or more audio mining components; and the second set of audio mining components may include one or more audio mining components.

An audio mining component may include: a speech/non-speech detecting component, a speaker change detecting component, a topic detecting component, a named-entity detecting component, a volume detecting component, and a language detecting component.

The generated supplemental information may include information representative of one or more segment types present in at least the first channel, the second channel, or both.

The one or more segment types may include one or more of the following: no speaker detected, one channel-specific speaker detected, and multiple concurrent channel-specific speakers detected.

The method of generating the supplemental information may include redacting at least a portion of the first audio input signal to render its corresponding sensitive content unintelligible; and storing the portion of the first audio input signal as supplemental information metadata.

Other general aspects include other combinations of the aspects and features described above and other aspects and features expressed as methods, apparatus, systems, computer program products, and in other ways.

Other features and advantages of the invention are apparent from the following description, and from the claims.

### DESCRIPTION OF DRAWINGS

FIG. 1 shows a block diagram of first implementation of a contact center service system.

FIG. 2 shows a block diagram of a second implementation of a contact center service system.

FIG. 3 shows a block diagram of an audio mining module.

FIG. 4 shows a block diagram of a channel reconstruction engine.

### DESCRIPTION

### 1 Contact Center Context

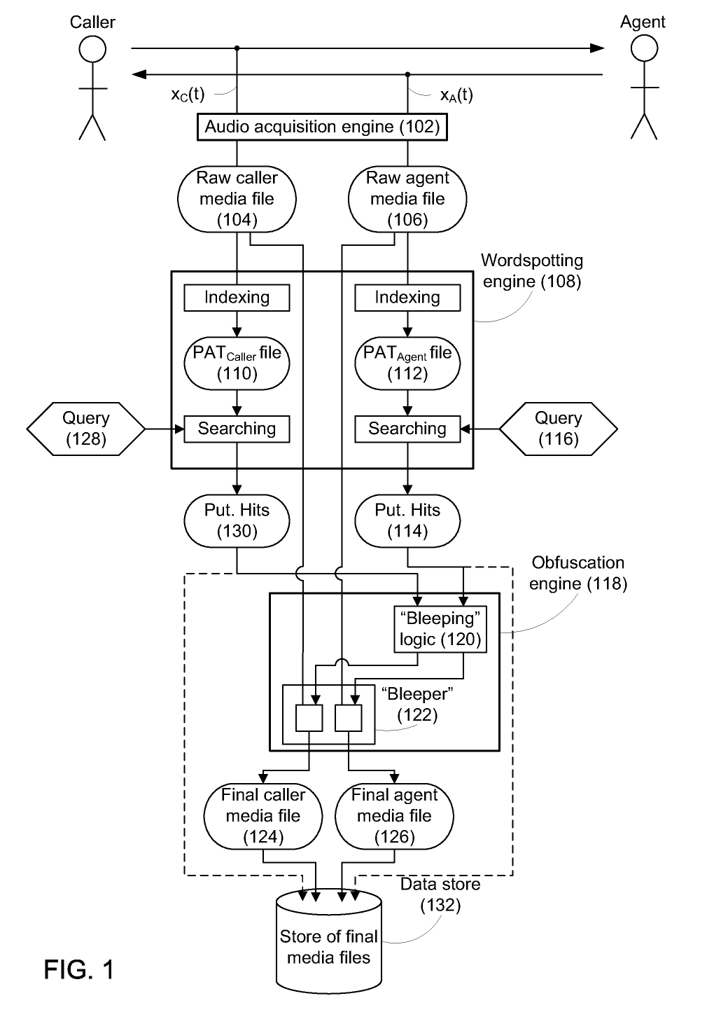

Referring to FIG. 1, a contact center service system 100 is configured to process sensitive content in an audio source representative of an interaction between a contact center caller and a contact center agent to obfuscate the sensitive content, for instance, by automatically detecting the content and limiting storage or and/or access to such content.

Very generally, a caller contacts a contact center by placing telephone calls through a telecommunication network, for example, via the public switched telephone network (PSTN). In some implementations, the caller may also contact the contact center by initiating data-based communications through a data network (not shown), for example, via the Internet by using voice over internet protocol (VoIP) technology.

Upon receiving an incoming request, a control module of the system 100 uses a switch to route the customer call to a contact center agent. The connection of an agent's telephone to a particular call causes a Voice Response Unit (“VRU”) module in the system 100 to notify the caller that the call may be recorded for quality assurance or other purposes, and signal an audio acquisition module 102 of the system 100 to start acquiring signals that are being transmitted over audio channels associated with the caller and the agent. In the depicted two-channel example of FIG. 1, the audio acquisition engine 102 is coupled to the caller's telephone device via an audio channel (“CHAN_A”) and is further coupled to the agent's telephone device via an audio channel (“CHAN_B”). The audio acquisition engine 102 receives one audio input signal (“caller audio input signal” or x_{C}(t)) associated with the caller over CHAN_A, and receives another audio input signal (“caller audio input signal” or x_{A}(t)) associated with the agent over CHAN_B. The audio input signals encode information of various information types, including vocal interactions and non-vocal interactions.

In some implementations of the contact center service system 100 in which a stored audio record of the telephone call is desired, rather than directly storing the audio signals in a permanent archive, the audio input signals are stored as raw media files (e.g., raw caller media file 104 and raw agent media file 106) in a temporary data store (not shown) only for the period of time needed to process the media files and obfuscate any sensitive content that is identified within. Once the sensitive content is obfuscated, the raw media files 104, 106 are permanently deleted from the temporary data store.

During a pre-processing phase, a wordspotting engine 108 of the system 100 takes as input the raw media files 104, 106, and executes one or more queries to detect any occurrences of sensitive content. In some implementations, the wordspotting engine first performs an indexing process on each media file 104, 106. In the depicted example, the results of the indexing process are two phonetic audio track (PAT) files. The first PAT file (PAT_{Caller} file 110) is a searchable phonetic representation of the audio track corresponding to the caller audio input signal, and the second PAT file (PAT_{Agent} file 112) is a searchable phonetic representation of the audio track corresponding to the agent audio input signal.

During a search phase, the wordspotting engine 108 performs phonetic-based query searching on the PAT_{Agent} file 112 to locate putative occurrences (also referred to as “putative hits” or simply “Put. Hits 114”) of one or more queries (e.g., search term or phrase) in the PAT_{Agent} file 112. Details of implementations of the wordspotting engine 102 are described in U.S. Pat. No. 7,263,484, titled “Phonetic Searching,” issued Aug. 28, 2007, and U.S. patent application. Ser. No. 10/565,570, titled “Spoken Word Spotting Queries,” filed Jul. 21, 2006, U.S. Pat. No. 7,650,282, titled “Word Spotting Score Normalization,” issued Jan. 19, 2010, and U.S. Pat. No. 7,640,161, titled “Wordspotting System,” issued Dec. 29, 2009. The content of these patents and patent applications are incorporated herein by reference in their entirety.

One example of such phonetic-based query searching is described below in the context of an application (referred to herein as “CCV application”) that detects and obfuscates of all digit sequences representative of credit card verification codes. First, a context-based analysis includes searching the PAT_{Agent} file 112 to identify contextual patterns of words that occur within PAT_{Agent} file 112 is performed. Such contextual patterns of words (referred to generally as “query 116”) may include some combination of the following words: “credit card number,” “verification code,” “validation code,” “verification value,” “card verification value,” “card code verification,” “card code verification,” “security code,” “three-digit,” “four-digit,” “sixteen-digit,” “unique card code,” “got it,” “thank you”). The query 116 may be specified using Boolean logic, where connectors may represent distances between query terms. In one example, the query 116 may specify searching for the term “verification code” within the same sentence, or within five seconds of the terms “three-digit” or “four-digit.” In another example, the query 116 may specify searching for the term “verification code” within two seconds of the term terms “three-digit” or “four-digit” and within fifteen seconds of the term (“got it” OR “thank you”). Search results (Put. Hits 114) are a list of time offsets into the raw agent media file 106 storing the agent audio input signals, with an accompanying score giving the likelihood that a match to the query happened at this time.

Next, the context-based analysis includes passing the Put. Hits 114 to an obfuscation engine 118 of the system 100, which uses the Put. Hits 114 to locate likely sensitive time intervals (at times also referred to herein as “context-based caller intervals of interest”) in the raw caller media file 104 that should be obfuscated. Contextual patterns of words detected in the PAT_{Agent} file 112 effectively serve as a hint (i.e., increasing the likelihood) that part of the raw caller media file 104 in close time proximity may include content to be obfuscated. The obfuscation engine 118 can implement obfuscation logic 120 that, amongst other things, identifies the time of the raw caller media file 104 that corresponds to a speaker change (e.g., from agent to caller) following a putative hit. This time represents a start time of an interval of interest. The end time of the context-based caller interval of interest may correspond to a point in time after: (1) some fixed duration of time has elapsed (e.g., 10 seconds after the start time); or (2) some variable duration of time has elapsed (e.g., based in part on a determined speaking rate of the caller). The obfuscation engine 118 can also implement obfuscation logic 120 that identifies the time interval of the raw caller media file 104 that is straddled by multiple putative hits that satisfies a single query. One such example is the designation of the time of the raw caller media file 104 that occurs after the term “verification code” is located within two seconds of the term “three-digit” in the PAT_{Agent} file 112 as the start time of the context-based caller interval of interest, and the time of the raw caller media file 104 that precedes the detection of the term “got it” in the PAT_{Agent} file 112 as the end time of the context-based caller interval of interest.

Finally, in some implementations, the context-based analysis includes use of the obfuscation logic 120 to process each context-based caller interval of interest in the raw caller media file 104 and obfuscate its content. Such processing may include the generation of altered voice segments of the caller audio input signal corresponding to the specified interval of interest in the raw caller media file 104. In the depicted example, a voice segment may be altered by substantially masking its content through the overwriting of the content by a “bleeper” 122 with an auditory tone, such as a “bleep.” In other examples, a voice segment may be altered by substantially reducing its volume to render its content inaudible to a human listener or otherwise processed in the audio domain. In some examples, the processing effectively encrypts the voice segment. In some examples, an indication (e.g., an audio message) of why the voice segment was altered may be appended to or otherwise stored in association with the voice segment. In some examples, in lieu of altering the voice segment, the voice segment corresponding to the time interval of interest in the raw caller media file 104 is removed from the raw caller media file 104 prior to the commitment of the raw caller media file 104 to a permanent or semi-permanent storage module as a final caller media file 124.

In some implementations, the results of the context-based analysis are validated prior to obfuscating the content in the context-based caller intervals of interest. In one example, the PAT_{Caller} file 110 is examined to determine whether any portion of the PAT_{Caller} file 110 satisfies a grammar specification (e.g., three consecutive digits representative of a three-digit verification code) for sensitive content. Such grammar specifications for sensitive content may be specified using a predefined set of queries 128. The wordspotting engine 108 performs phonetic-based query searching on the PAT_{Caller} file 110 to locate putative occurrences (also referred to as “putative hits” or simply “Put. Hits 130”) of one or more the queries 128 in the PAT_{Caller} file 110, and passes the Put. Hits 130 to the obfuscation engine 118. The bleeping logic 120 can be implemented to examine each of the Put. Hits 130 to determine whether the Put. Hit 130 falls within a context-based caller interval of interest. A positive result validates the result of the context-based analysis and the content within the context-based caller interval of interest is obfuscated by the bleeper 122. In some implementations, the entirety of the content within the context-based caller interval of interest is obfuscated. In other implementations, only the portion of the context-based caller interval of interest that corresponds to its Put. Hit 130 is obfuscated. In those instances in which the examination yields a negative result, no action is taken by the bleeper 122 with respect to the context-based caller interval of interest.

In some implementations, the obfuscation engine 118 of the system 100 uses the Put. Hits 114 to locate interesting time intervals (at times also referred to herein as “context-based agent intervals of interest”) in the raw agent media file 104 that should be obfuscated. Contextual patterns of words detected in the PAT_{Agent} file 112 serve as a hint that part of the raw agent media file 104 in close time proximity may include content to be obfuscated. Suppose, for example, the query 116 specifies searching for the terms “did you say” or “I'm going to repeat” within the same sentence or within ten words of the terms “verification code” and “three-digit.” The obfuscation engine 118 can implement obfuscation logic 120 that, amongst other things, determines whether any portion of the PAT_{Agent} file 112 satisfies a grammar specification (e.g., three consecutive digits representative of a three-digit verification code) for sensitive content, and obfuscates the sensitive content if the examination yields a positive result. In this manner, the sensitive content representative of the three-digit verification code is not only obfuscated in the final caller media file 106 but also the final agent media file 126.

In the depicted example of FIG. 1, the final caller media file 106 and the final agent media file 126 are stored in a permanent or semi-permanent storage module 132. The Put. Hits 114, 130 are optionally stored in the storage module 132. Further analysis may be performed on the final media files 124, 126 at a later time. Details of implementations of such analysis techniques are described in U.S. patent application Ser. No. 12/429,218, titled “Multimedia Access,” filed Apr. 24, 2009, U.S. patent application Ser. No. 61/231,758, titled “Real-Time Agent Assistance,” filed Aug. 6, 2009, and U.S. patent application Ser. No. 12/545,282, titled “Trend Discovery in Audio Signals,” filed Aug. 21, 2009. The contents of these three applications are incorporated herein by reference.

Although one implementation of the present invention is described above in a batch mode context, the techniques of the present invention are also applicable in a real-time context, in which the raw media files 104, 106 are processed at about the time the speech is uttered by the speakers and the final media files 124, 126 are made available to a listener in real-time shortly thereafter. For example, in a near real-time monitoring application, a person monitoring the telephone conversation may hear a beep in place of sensitive information.

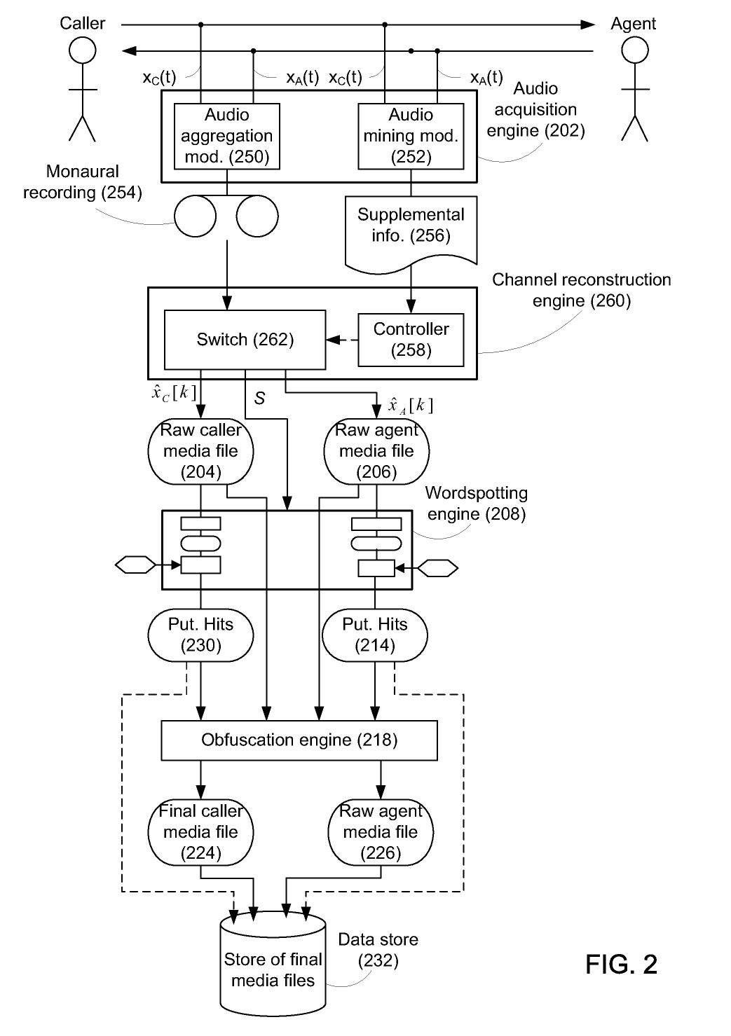

Referring now to FIG. 2, in some implementations, a contact center service system 200 has an audio acquisition engine 202 that is implemented with an audio aggregation module 250 and an audio mining module 252. The audio aggregation module 250 uses conventional techniques to combine the caller audio input signal x_{C}(t) and the agent audio input signal x_{A}(t) to form a monaural recording 254 x_{C}(t)+x_{A}(t) of the caller-agent call.

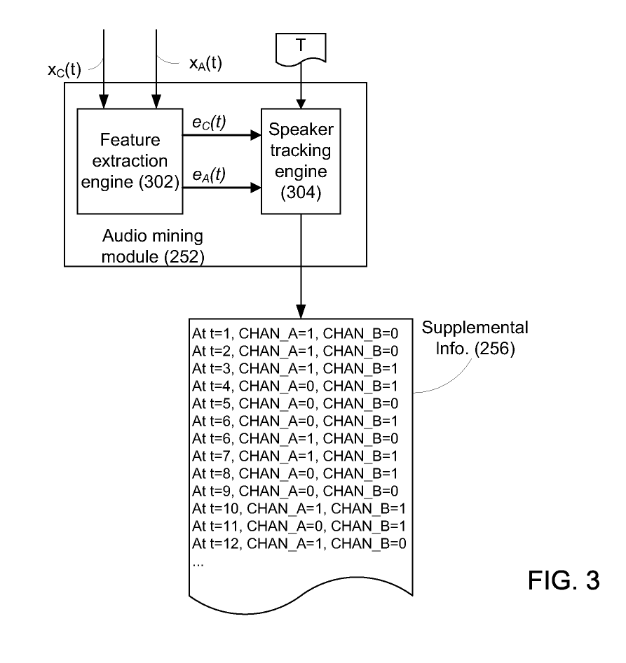

The audio mining module 252 processes the audio input signals on a per-channel basis to generate information (referred to in this description as “supplemental information” 256) that is representative of characteristics of the audio signal(s) being processed. Some of the supplemental information 256 may be representative of characteristics of a single audio input signal, while others of the supplemental information 256 may be representative of characteristics of multiple audio input signals relative to one another. Referring also to FIG. 3, the audio mining module 252 may include one or more feature extraction engines 302 implemented to measure features f such as power, short term energy, long term energy, zero crossing level and other desired features of the caller audio input signal and the agent audio input signal during some portion of a frame period using conventional feature extraction techniques. In one example, the features are obtained periodically during each 2.5 ms of a frame period. Based on the types of feature extraction engines 302 a given audio mining module is implemented with, any number and combination of types of supplemental information 256 may be generated and stored in association with a monaural recording. At a minimum, the audio mining module 252 is implemented so that at least some portion of the generated supplemental information 256 is sufficient to enable a channel reconstruction engine 260 to derive information associated with one or more distinct audio input signals from the monaural recording 254.

The process of generating the monaural recording 254 may be performed by the audio aggregation module 250 concurrent with, or within close temporal proximity of, the processing of the audio input signals by the audio mining module 252.

Referring again to FIG. 3, in some implementations, the features f that are extracted by the feature extraction engine(s) 302 from the caller audio input signal x_{C}(t) and/or agent audio input signal x_{A}(t) are provided to a speaker tracking engine 304 of the audio mining module 252. In one example, the features f include values representative of a short term energy e_{C}(t) of the caller audio input signal x_{C}(t) and a short term energy e_{A}(t) of the agent audio input signal x_{A}(t) in decibels (dB) for each frame period. The speaker tracking engine 304 compares each of e_{C}(t) and e_{A}(t) with a threshold value T to differentiate between voice and noise per audio input signal per frame period and generates supplemental information as follows:
If e_{C}(t) is greater than the threshold value T, classify caller audio input signal for that frame period as voice and generate supplemental information of CHAN_A (t)=1;
If e_{C}(t) is less than the threshold value T, classify caller audio input signal for that frame period as noise and generate supplemental information of CHAN_A (t)=0;
If e_{A}(t) is greater than the threshold value T, classify agent audio input signal for that frame period as voice and generate supplemental information of CHAN_B (t)=1;
If e_{C}(t) is less than the threshold value T, classify agent audio input signal for that frame period as noise and generate supplemental information of CHAN_B (t)=0.
The supplemental information 256 is passed to a controller 258 of a channel reconstruction engine 260, which selectively connects the monaural recording x_{C}(t)+x_{A}(t) (functioning as an input line) to one of two data output lines so as to reconstruct the input signals of CHAN_A and CHAN_B from the monaural recording.

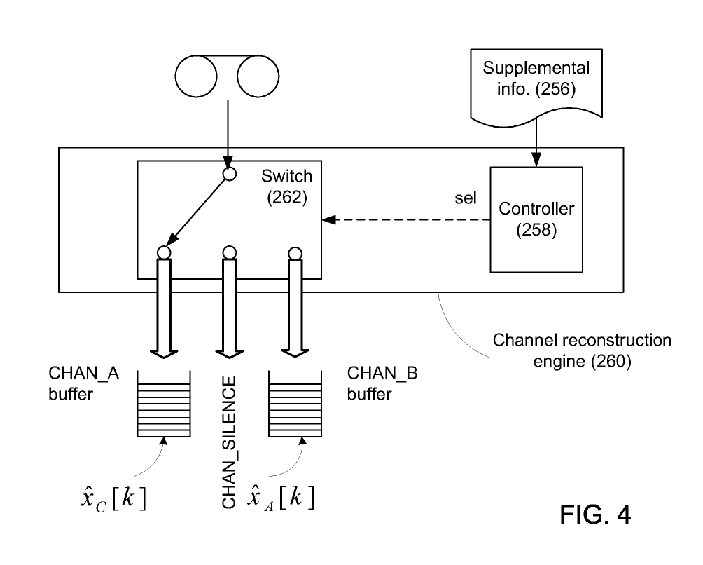

Referring also to FIG. 4, generally, the controller 258 is implemented to do the following:
If supplemental information 254 indicates that CHAN_A=1, CHAN_B=0, control switch 262 to connect the monaural recording 254 to CHAN_A channel and collect samples of the monaural recording x_{C}(t)+x_{A}(t) in CHAN_A buffer, where the collected samples \hat{x}_{C}[k] are predicted to correspond to the caller audio input signal for that frame period;
If supplemental information 254 indicates that CHAN_A=0, CHAN_B=1, control switch 262 to connect the monaural recording 254 to CHAN_B channel and collect samples of the monaural recording x_{C}(t)+x_{A}(t) in CHAN_B buffer, where the collected samples \hat{x}_{A}[k] are predicted to correspond to the caller audio input signal for that frame period;
If supplemental information indicates that CHAN_A=1, CHAN_B=1 or CHAN_A=0, CHAN_B=0, control switch 262 to connect the monaural recording 254 to CHAN_SILENCE channel and send a signal S to the wordspotting engine 108, wherein signal S contains information indicative of the frame period to ignore during the search phase.

In the depicted examples of FIG. 2, the samples \hat{x}_{C}[k] are collected in a raw caller media file 204 and the samples \hat{x}_{A}[k] are collected in a raw agent media file 206. Like the example described above with respect to FIG. 1, the raw media files 204, 206 are stored in a temporary data store (not shown) only for the period of time needed to process the raw media files and obfuscate any sensitive content that is identified within. Once the sensitive content is obfuscated, the raw media files 204, 206 are permanently deleted from the temporary data store.

During a pre-processing phase, a wordspotting engine 208 of the system 200 takes as input the raw media files 204, 206, and performs an indexing process on each media file 204, 206 to generate a PAT_{Caller} file and a PAT_{Agent} file. During a search phase, the wordspotting engine 208 performs phonetic-based query searching on the PAT_{Agent} file to locate putative occurrences “Put. Hits 214” of one or more queries (e.g., search term or phrase) in the PAT_{Agent} file. The Put. Hits 214 are passed to an obfuscation engine 218 of the system which performs a context-based analysis and optionally performs a content-based validation as described above with respect to FIG. 1. In the depicted example of FIG. 2, the final caller media file 206 and the final agent media file 226 are stored in a permanent or semi-permanent storage module 232. The Put. Hits 214, 230 are optionally stored in the storage module 232. Further analysis may be performed on the final media files 224, 226 at a later time.

### 2 Other Implementations

In some implementations, the audio mining module 252 includes a volume detection engine that processes the audio input signals on a per-channel basis to generate supplemental information indicative of a speaking level on each channel.

In some implementations, the audio mining module 252 includes a sampling engine that processes the audio input signals on a per-channel basis to generate supplemental information indicative of a rate at which the original waveform is being sampled (e.g., once every 2 ms).

Other variants are possible. For example, the supplemental information may be based on other sources of information than volume on the original channels. For example, signal processing or speaker identification techniques may be used on an already-combined signal to re-generate appropriate supplemental information for further speech processing on the channels.

Other types of segmentation may also be provided, for example, according to the language being spoken. For example, in some calls, the language may switch mid-call. Other aspects of each channel may also be provided, e.g., identification of the gender on each channel.

The function of generating the supplemental information may be integrated into a call logging system. Alternatively, a parallel process to call logging may be used to generate the supplemental information.

The foregoing approaches may be implemented in software, in hardware, or in a combination of the two. In some examples, a distributed architecture is used in which the techniques implemented by the audio acquisition module are performed at a different location of the architecture than those implemented by the audio aggregation module and/or the audio mining module. In some examples, a distributed architecture is used in which the wordspotting stage is performed at a different location of the architecture than the automated speech recognition. For example, the wordspotting may be performed in a module that is associated with a particular conversation or audio source, for example, associate with a telephone for a particular agent in a call center, while the automated speech recognition may be performed in a more centralized computing resource, which may have greater computational power. In examples in which some or all of the approach is implemented in software, instructions for controlling or data imparting functionality on a general or special purpose computer processor or other hardware is stored on a computer readable medium (e.g., a disk) or transferred as a propagating signal on a medium (e.g., a physical communication link).

It is to be understood that the foregoing description is intended to illustrate and not to limit the scope of the invention, which is defined by the scope of the appended claims. Other embodiments are within the scope of the following claims.

What is claimed is:

1. A method of logging multi-channel audio signals, the method comprising:
receiving a first audio input signal over a first audio channel and a second audio input signal over a second audio channel, the first audio channel and the second audio channel forming portions of a multi-channel call;
generating supplemental information representative of characteristics of the first audio input signal, the second audio input signal, or both;
after generating the supplemental information, combining the first audio input signal and the second audio input signal to form an audio output signal of a single-channel format; and
storing the generated supplemental information in association with an identifier of the audio output signal,
wherein at least a portion of the generated supplemental information is sufficient to enable information associated with the first audio input signal, the second audio input signal, or both to be derived from the audio output signal of the single-channel format.

2. The method of claim 1, wherein generating the supplemental information comprises one or more of:
processing the first audio input signal either fully or in part with a first set of audio mining components to identify characteristics of the first audio input signal; and
processing the second audio input signal either fully or in part with a second set of audio mining components to identify characteristics of the second audio input signal.

3. The method of claim 2, wherein the first set of audio mining components is identical to the second set of audio mining components.

4. The method of claim 2, wherein:
the first set of audio mining components includes one or more audio mining components; and
the second set of audio mining components includes one or more audio mining components.

5. The method of claim 2, wherein an audio mining component comprises: a speech/non-speech detecting component, a speaker change detecting component, a topic detecting component, a named-entity detecting component, a volume detecting component, and a language detecting component.

6. The method of claim 1, wherein the generated supplemental information includes information representative of one or more segment types present in at least the first channel, the second channel, or both.

7. The method of claim 6, wherein the one or more segment types comprise one or more of the following: no speaker detected, one channel-specific speaker detected, and multiple concurrent channel-specific speakers detected.

8. The method of claim 1, wherein generating the supplemental information comprises:
redacting at least a portion of the first audio input signal to render its corresponding sensitive content unintelligible; and
storing the portion of the first audio input signal as supplemental information metadata.
